(19) United States
(12) Patent Application Publication
(10) Pub. No.: US 2015/0309208 A1
(43) Pub. Date: Oct. 29, 2015

(54) SYSTEMS AND METHODS FOR LOCALIZED HAIL ACTIVITY ALERTS

(71) Applicant: Dynamic Weather Solutions, Inc, Plano, TX (US)

(72) Inventors: Daron Sneed, Plano, TX (US); George Baugh, Dallas, TX (US)

(21) Appl. No.: 14/679,021

(22) Filed: Apr. 5, 2015

Related U.S. Application Data
(60) Provisional application No. 61/975,810, filed on Apr. 5, 2014.

(51) Int. Cl. G01W 1/14; G01W 1/02; G01C 21/00

(52) U.S. Cl. CPC G01W 1/14; G01C 21/00; G01W 1/02

(57) ABSTRACT

The present invention is directed to system and method of forecasts, displays, and alerts for localized hail activity. An exemplary method comprises the steps of selecting a region to monitor, receiving meteorological data for that region, processing the meteorological data for storm cell and hail activity in order to determine hail risk activity. The system forecasts the direction of an active storm as well a user position. Probability bands of hail risk activity are created for display. Optionally, an alert is generated when the user position is in or proximate a threshold probability band.

### PRIORITY

The present invention claims priority to provisional application 61/975,810, which has a filing date of Apr. 5, 2014 and is incorporated by reference.

### FIELD OF THE INVENTION

The present invention relates to systems and processes for meteorological data processing, and more specifically to systems and methods of forecasts and notification of localized hail activity.

### DESCRIPTION OF THE RELATED ART

It is desirable for a person to have hail activity risk data at their specific location. It is even more desirable for that person to have hail activity risk data during travel along their route. Based upon the hail activity risk data, the person may take appropriate action to avoid injury to themselves or damage to their vehicle by taking shelter or altering the travel path in response to possible hail in their current proximity or intended proximity.

First, current hail activity display and notification typically notify users by broad geographic area, typically over a metropolitan area. Even National Oceanic and Atmospheric Administration (NOAA) radio transmits alerts by broad geographic area or by a station ID. Secondly, the hail activity display and notification fail to include potential severity of the hail condition in a non-distracting format for ready consumption in order to take meaningful action in response to the hail activity risk.

Moreover, weather forecasts are generally only reliable and valid for some period following their generation. Once a person is en route, the weather conditions may be updated so as to take account changes in weather conditions, and in turn the hail activity risk. Managing the forecast data and maintaining situational awareness, especially while traveling, can decrease attention due to the necessary focus on the data.

For the above reasons, it would therefore be advantageous to have systems and methods of creation, display, and alert of hail activity risk data for a localized area in a readily perceptible format.

### SUMMARY

Exemplary embodiments of the present invention are directed to systems and methods for monitoring and notification of localized hail activity. An embodiment of method of the current invention comprises the steps of receiving contemporaneous user position information, defining a weather monitoring zone encompassing the user position, defining a user travel zone encompassing the user position and within the weather monitoring zone. The system receives meteorological data for the weather monitoring zone from at least one meteorological data source. The system determines hail risk within a storm cell for the user travel zone, projects a subsequent user position, and projects a subsequent storm cell position. The system compares the position data of the user travel zone with the position data of the hail risk in the storm cell for overlap, and determines user hail risk as a function of the projected user position and the projected storm cell position.

These and other features, aspects, and advantages of the invention will become better understood with reference to the following description, and accompanying drawings.

### BRIEF DESCRIPTION OF THE DRAWINGS

FIG. 1 depicts elements of an embodiment of a system according to the current invention;

FIG. 2 depicts a flowchart of the major steps of a process implemented to an embodiment of a system according to the current invention;

FIG. 3 depicts a flowchart of a representative subset of the process of FIG. 1;

FIG. 4 depicts a representative partial database schema for input into the process and system of FIG. 3;

FIG. 5 depicts representative storm cell activity center and representative hail activity monitoring zone;

FIG. 6 depicts a representative storm cell activity travel vector;

FIG. 7 depicts representative storm cell activity travel within a hail activity monitoring zone;

FIG. 8 depicts a representative historical cell activity travel vector, present cell activity travel vector, and forecast cell activity bands in a storm cell;

FIG. 9 depicts a representative historical cell activity travel vector, present cell activity travel vector, and forecast cell activity bands within a hail activity monitoring zone; and

FIG. 10 depicts a representative historical cell activity travel vector, present cell activity travel vector, and forecast cell activity bands within a hail activity monitoring zone.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

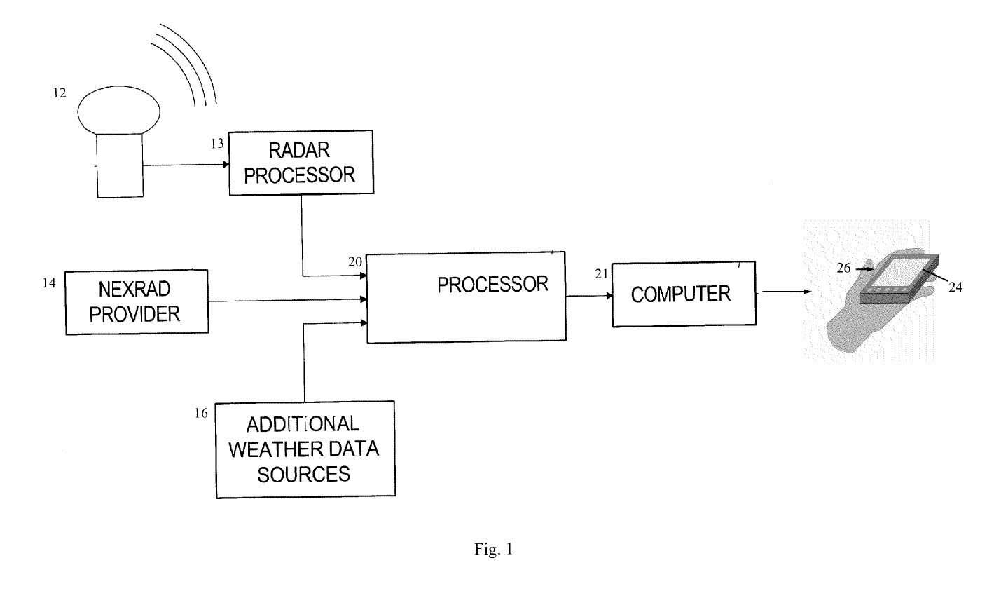

Exemplary embodiments of the present invention are directed to systems and processes for monitoring hail risk activity for a selected local area and presenting a graphical representation or generating a notification based upon the same. Referring to FIG. 1, the major components of embodiments of the system 10 are presented. Meteorological data sources 12 13 14 16, a processor 20 of a computer 21, and a personal computer 26 having a display 24 are illustrated.

In certain embodiments, doppler radar 12 in communication with a radar processor 13 as a source of meteorological data is shown. NEXRAD 14, as an alternate source of meteorological data is shown. Additional data sources 16, such as alternate online providers, may exist as another source of meteorological data is also shown. One exemplary meteorological data source is the current and historical weather products of NOAA, NEXRAD, or the National Climatic Data Center (NCDC). A computer 21 having a processor 20 compiles, processes, and stores meteorological data. The processor 20 outputs data packets for transmission and presentation on a display 24 of a user computer 26.

A computer 21 26 as referred to in this specification generally refers to a system which includes a central processing unit (CPU), memory, a screen, a network interface, and input/output (I/O) components connected by way of a data bus. The I/O components may include for example, a mouse, keyboard, buttons, or a touchscreen. The network interface enables data communications with the computer network. A server is a computer 21 containing various server software programs and preferably contains application server software. A minicomputer is a computer 21 26 such as a smartphone or tablet PC with smaller dimensions, such as iPhone, iPod Touch, iPad, Blackberry, or Android based device. Those skilled in the art will appreciate that computer 21 26 may take a variety of configurations, including personal computers, hand-held devices, multi-processor systems, microprocessor-based electronics, network PCs, minicomputers, mainframe computers, and the like. Additionally, the computer 21 26 may be part of a distributed computer environment where tasks are performed by local and remote processing devices that are linked. Although shown as separate devices, one skilled in the art can understand that the structure of and functionality associated with the aforementioned elements can be optionally partially or completely incorporated within one or the other, such as within one or more processors. As noted above, the processes of this invention, or subsets thereof, may exist in on one or more computers such as a client/server approach. The process, or subsets thereof, may exist in a machine-readable medium. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention or aspects thereof may be downloaded as a computer program or “app” which may be transferred from a remote computer to a requesting computer by way of data signals embodied in a carrier wave or other propagation medium via a communication link.

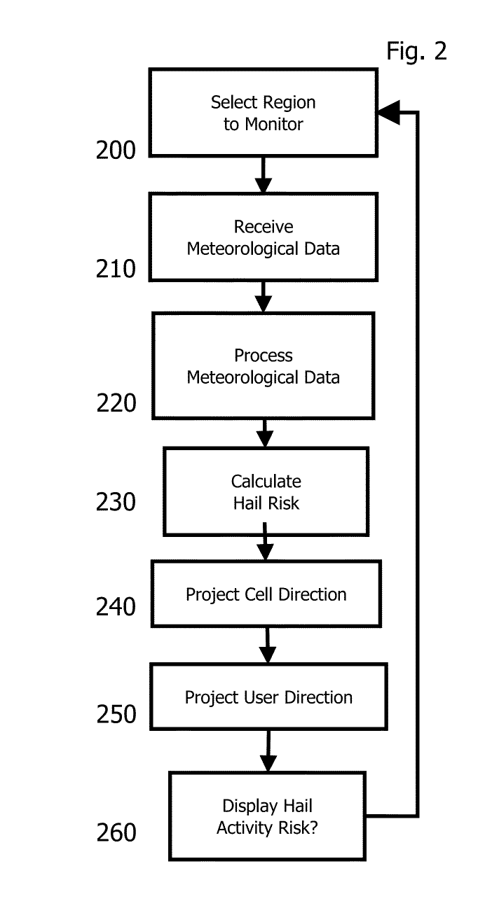

Referring to FIG. 2, an exemplary process of forecasting and displaying hail activity risk is shown. The system 10 receives a geographic area to monitor 200. The meteorological data for the selected geographical area for the selected time frame is received 210. The received meteorological data for the selected geographical area for the subject time frame is processed 220. The system 10 determines the likelihood of hail activity in the subject geographic area 230. The system 10 projects active storm cell direction 240. The system 10 projects user direction 250. The system 10 displays hail activity information 260. Each of these steps will be considered in more detail below.

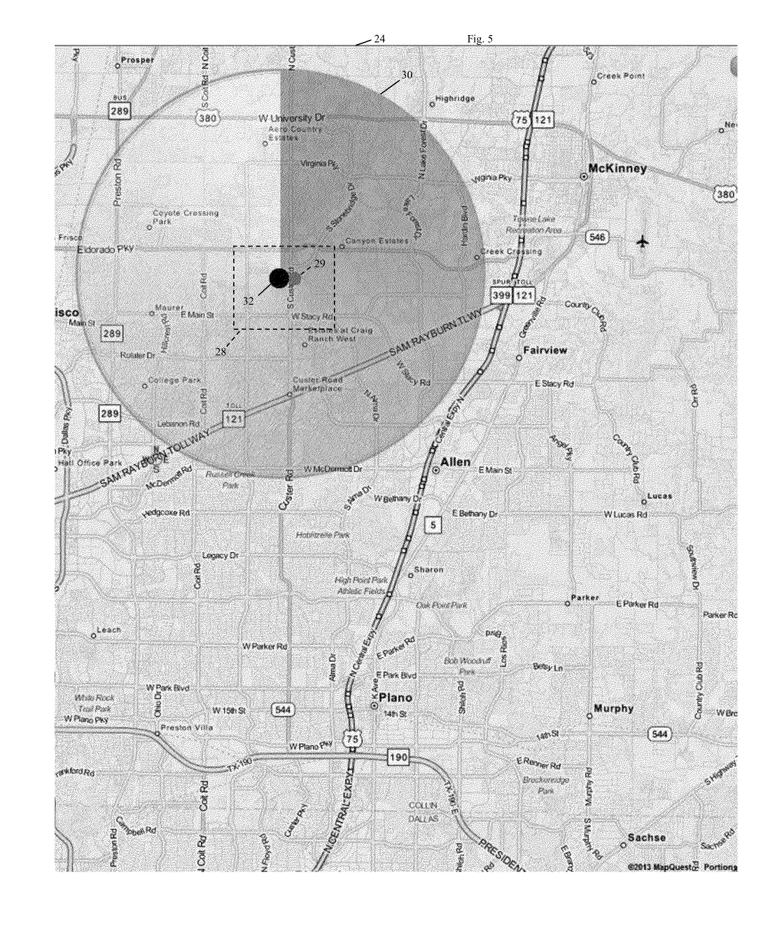

Now referring to FIG. 5, at step 200, the system 10 receives a geographic area to monitor for hail activity. The system 10 determines position information for a user in order to determine a user position 29, for example in the form of latitude and longitude coordinates. In one configuration, the user enters an address. The system 10 performs a lookup of the address to retrieve the corresponding latitude and longitude coordinates. In other configurations, the system 10 directly receives user position 29 information in an automated manner from sources such as a personal computer 26 GPS, standalone GPS, vehicle mounted GPS, OnStar, or other devices. It should be appreciated that other forms of geocoding are within the spirit of this invention. Based on the user position 30, current and past (where available), the system optionally defines a user travel zone 28 representing an area in which the user is likely to be in the near term. Factors influencing the user travel zone 28 size include user velocity, available travel routes, and other factors. For example, where there is only a single or limited corridors for a route or segments thereof, size in the anticipated direction of travel can be elongated in that direction.

The system 10 defines a weather monitoring zone 30 including the user position 29 and user travel zone 28. The weather monitoring zone 30 is a system selected distance or range of distances from the user position 29. Factors influencing the weather monitoring zone 30 size include the storm cell center 32, the storm sell size, user velocity, storm cell velocity, wind speed, and other factors. Again, as an example, where there is only a single or limited corridors for a route or segments thereof, size in the anticipated direction of travel can be elongated in that direction.

At step 210, the system 10 receives meteorological data for the subject weather monitoring zone 30. Exemplary meteorological data sources 14 16 include the current and historical weather products of NOAA, NEXRAD, or the National Climatic Data Center (NCDC). More specifically, the NOAA Hail Index and nx3hail weather products. Exemplary processed meteorological data includes active storm cells, storm cell identification numbers, storm cell position, storm cell size, storm cell direction, and probability of severe hail.

At steps 220 and 230, the meteorological data 14 16 is processed to forecast hail activity risk. In exemplary configuration, the system calculates the probability of hail for a representative sample of the user travel zone 28 or the weather monitoring zone 30, with the probabilities of hail corresponding to their respective coordinates.

In one configuration, the available probability of severe hail data is retrieved from the weather product for points within the user travel zone 28 or the weather monitoring zone 30.

In certain configurations, the system 10 employs the hail probability calculations disclosed in U.S. patent application Ser. No. 14/071,414 to Sneed, which is hereby incorporated by reference. It is further disclosed below, as necessary.

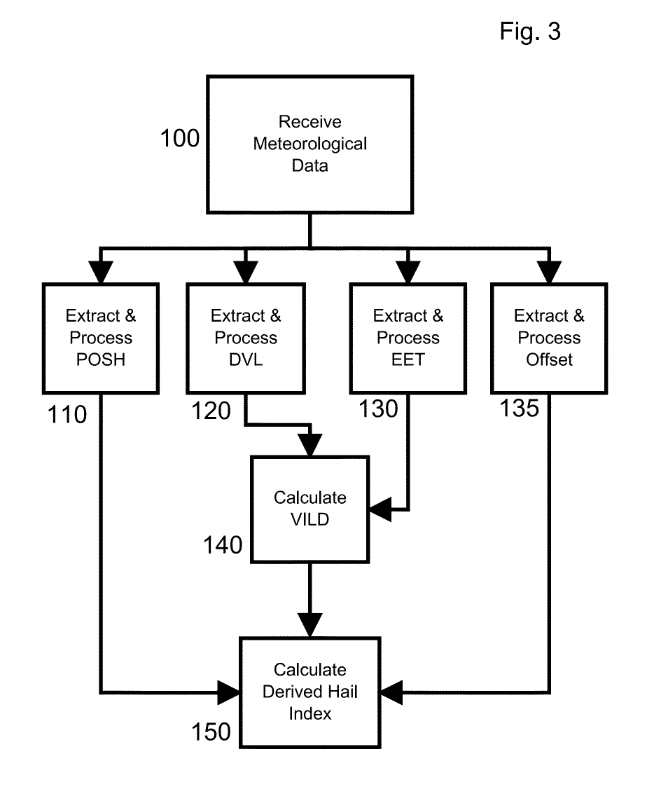

Referring to FIG. 3, the system 10 receives meteorological data for a selected geographical area for a selected time frame 100. The system 10 processes and transforms the received meteorological data. The system 10 then generates a data packet representing hail intensity overlay data in the form of a derived hail intensity index.

Still referring to FIG. 3, a more detailed disclosure of the above embodied process is shown. The system 10 receives meteorological data for the weather zone 100. In one configuration, doppler radar units are C-band or X-band Doppler meteorological surveillance radar with automatic computer processing systems. The system may further include S-band to supplement. These radar units provide measurement of both reflectivity and velocity of liquid and can scan volumetrically to produce detailed data. In a reflectivity mode, the liquid echoes are scaled to correspond directly to values of liquid content. In velocity mode, the radar measures the movement of scattering particles along the radar beam. In one configuration, meteorological data including precipitation, cloud cover data, the bottom and top of cloud formations, and reflectivity and velocity of liquid are acquired from C-band Doppler radar, which is combined with NEXRAD data, and the data is digitized and stored for real-time, near real-time, or historical processing. The full volumetric data of the storm enables the system to “slice” a storm to view cross sections from various angles, and from various vantage points. The meteorological data sources 12 13 14 16, directly or indirectly, and without exclusion, can include data products such as rainfall intensity, reflectivity, composite reflectivity, clear air mode, precipitation mode, echo tops, vertical integrated liquid, surface rainfall accumulation, radial velocity, velocity azimuth display winds, winds aloft, wind shear, microburst activity, and the like.

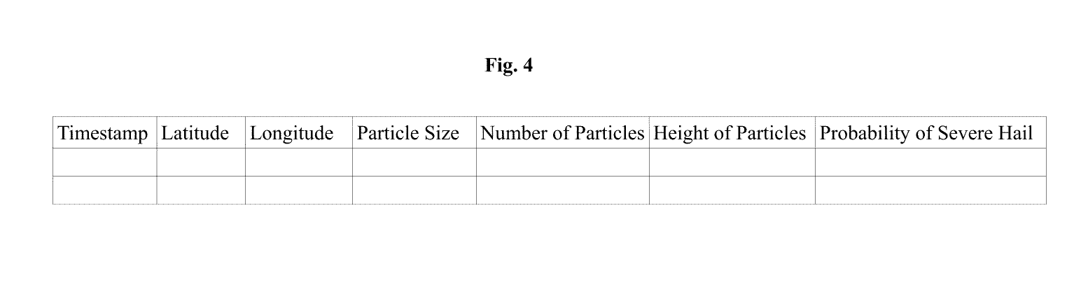

FIG. 4 shows a representative partial database schema for input to the current configuration of the system 10. It includes series of rows or “slices” having a timestamp for a particular set of data, a latitude and latitude, water particle size, number of water particles, the height of those water particles, and the probability of severe hail (“POSH”). It is to be understood that the input meteorological data can be pre-processed prior to input to the system 10 or post-processed for use by the system 10. For example, as the basis of the data in this configuration is received from radar incident or at an angle relative to the atmosphere being sampled, latitude and longitudinal data for the ground position of the sampled air column is computed as known in the art. For example, water particle size may represent an average of an array of water particles within the particular data set. In an exemplary configuration, the meteorological data is received from external sources, preferably the National Climactic Data Center NEXRAD Data Inventory 14.

In certain embodiments, the system 10 supplements the radar data 12 or NEXRAD data 14 with additional data sources 16.

The system 10 processes the meteorological data in plural data channels 110 120 130. A first data channel is the hail index 110 for use in locating storm cells which have the potential to produce hail. More specifically, the preferred subset of hail index information is the probability of severe hail 110 data, which indicates the probability of severe hail within the area of representing the particular dataset. It is commonly represented by a value between zero and one hundred percent. In a first configuration, it is derived from the input meteorological data. In a second configuration, it is derived from the input meteorological data and provided by a third party. Additional information on the derivation of hail index and probability of severe hail is annexed and incorporated by reference.

A second data channel is the vertically integrated liquid 120 data, which is useful in determining the amount of precipitation that the radar detects in a vertical column of the atmosphere for an area. It is determined as known in the art. In a first configuration, it is derived from the input meteorological data. In a second configuration, it is derived from the input meteorological data and provided by a third party. Additional disclosure of vertical integrated liquid calculation is annexed and incorporated by reference.

A third data channel is the enhanced echo tops 130, which is useful in determining the peak height of an atmospheric area of precipitation. It is determined as known in the art. In a first configuration, it is derived from the input meteorological data. In a second configuration, it is derived from the input meteorological data and provided by a third party. Additional disclosure of enhanced echo tops determination is annexed and incorporated by reference.

Having the enhanced echo top 130 and the vertically integrated liquid 120 data, the system 10 calculates the vertically integrated liquid (VIL) density 140. This embodiment calculates the VIL density as known in the art. This embodiment employs the following formula:

(VIL/Echo Top)*1000

to yield a value in g/m³.

An optional fourth data channel is the spatial offset 135, which is useful in determining potential spatial offset of hail position from atmospheric formation to ground level impact. The spatial offset is determined determining the hail potential for a given area. The system starts with the hail's anticipated position at an enhanced echo top above ground level. A vector is formed applying the gravitational constant from that altitude to ground level. The vector is adjusted based on storm motion and wind direction data. More specifically, vectors from fields such as radial velocity, velocity azimuth display winds, winds aloft, wind shear, and microburst activity at different altitudes between the echo top and ground level are accumulated. An offset value for ground level (or proximate ground level) is calculated and applied.

Having the VIL density and probability of severe hail data, the system 10 prepares a series of data packets to facilitate display of hail activity. In addition to the visual map data, each data packet contains hail activity overlay data. The data packets represent map data and hail activity overlay for a selected geographic area and a selected time window, each data packet representing a single frame of the same dimension. Each data packet contains hail activity data for the same selected geographic area. That is to say the geographic boundaries represented by each of the data packets is the same. Further, a coordinate, typically an x, y cartesian coordinate or the like, representing a pixel in one data packet corresponds to the same underlying position within the selected geographic area across the series of data packets.

Each data packet is based on meteorological data from a single time slice, with the series of data packets representing a chronologically ordered sequence of hail activity proximate the currently processed subject time. The data packet is structured for transformation to an image showing hail activity in that time slice or subset thereof.

As previously mentioned, the data packets include hail activity overlay data corresponding to given coordinates. The hail activity overlay data is based on a derived hail index 150. In an exemplary configuration, each point or pixel in the geographic area represented by the data packet includes a derived hail index number. In the current embodiment, the derived hail index is a scaled number representing the intensity of the hail activity, indicating how the system 10 should represent the data packet in its transformation for hail risk. In one configuration, a high derived hail index indicates high hail activity.

In computing the derived hail index 150, the current embodiment of the system 10 retrieves the probability of severe hail 110 data, the vertically integrated liquid 120 data, the enhanced echo tops 130 data, and VIL density 140 data for an area. The input meteorological data includes probability of severe hail 110 data. This is commonly available for an area within the selected geographic region. However, the area corresponding those input points varies depending on radar processing resolution, gaps due to radar scan intervals, and other factors. The applicable probability of severe hail 110 data of the input meteorological data is retrieved by selecting those points having a latitude & longitude within or adjacent the selected geographic region. VIL density 140 is commonly available as clusters and is retrieved from the meteorological data in a similar manner.

As previously disclosed, the exemplary embodiment of the system 10 assigns a derived hail index 150 to each data point within the data packet corresponding to a pixel to be displayed. The derived hail index is a number calculated based on the product of VILD and POSH. Optionally, the derived hail index is scaled. Where a probability of severe hail 110 data is available for pixel data representing a latitude/longitude position within the selected geographic region, one configuration of the system 10 for computing the derived hail index 150 employs the following formula:

Ceiling(VILD*(POSH/2)/100+VILD,max)

where VILD is vertically integrated liquid digital density for the cluster containing the latitude/longitude position, POSH is probability of severe hail for the latitude/longitude position, and max is the configured upper end of the scale.

In some cases, probability of severe hail 110 data is unavailable for pixel data representing a latitude/longitude. In such a case, the system will substitute or calculate a suitable probability of severe hail 110 point based on proximate POSH data within a pre-configured maximum distance threshold from available data. The maximum distance threshold is determined by comparing available probability of severe hail 110 data to VIL density 140 clusters, where a suitable proximate probability of severe hail 110 point is available. On one configuration, the system 10 employs the above disclosed formula to that point adjusted by the following distance adjustment formula:

((A COS(SIN(posh_lat*PI/180)*SIN(vild_p_lat*PI/180)+COS(posh_lat*PI/180)*COS(vild_p_lat*PI/180)*COS((posh_lon−vild_p_lon)*PI/180))*180/PI)*60*1.1515)

where posh_lat is the latitude of the proximate probability of severe hail point, vild_p lat is the latitude for the proximate VIL density cluster, posh_lon is the longitude of the proximate probability of severe hail point, vild_p_lon is the longitude for the proximate VIL density cluster.

After steps 220 and 230, hail activity risk values are stored in the form of probability of severe hail or a derived hail index for the respective coordinates for the given time slice.

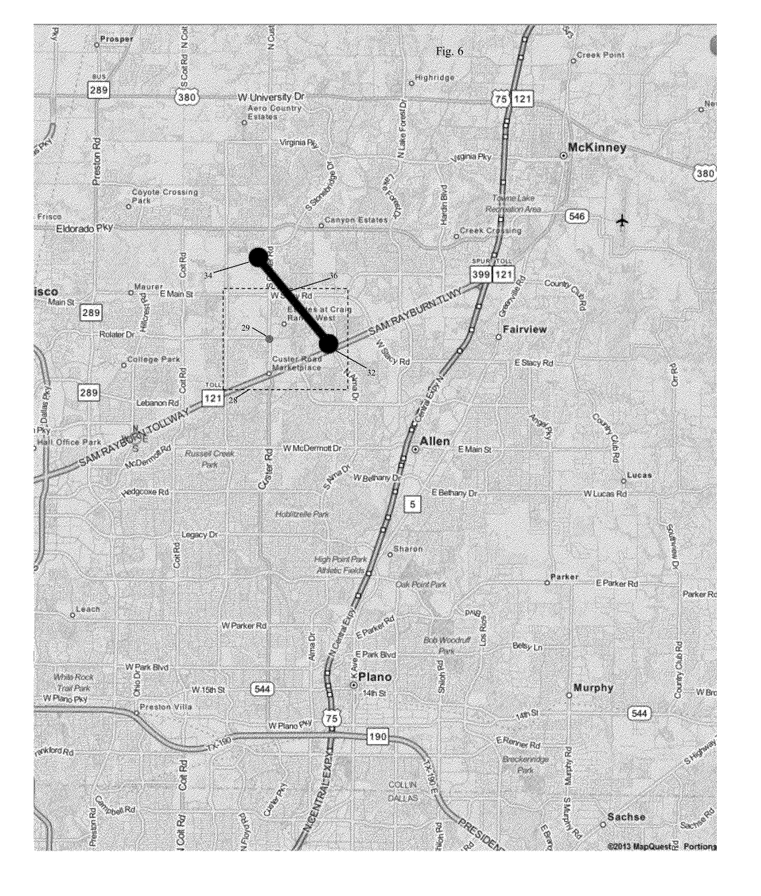

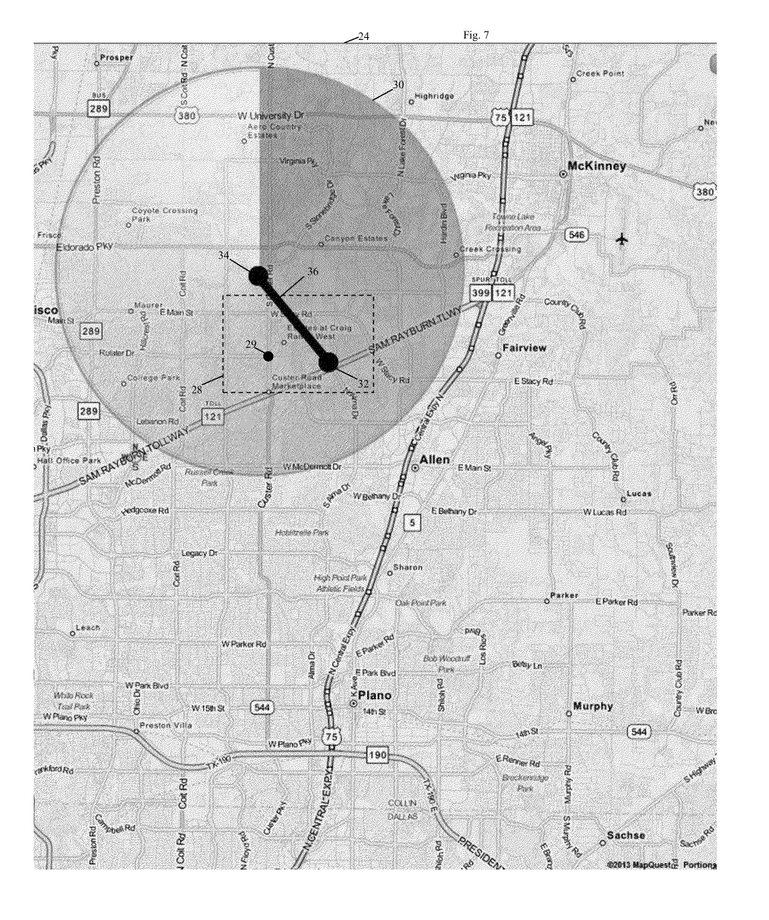

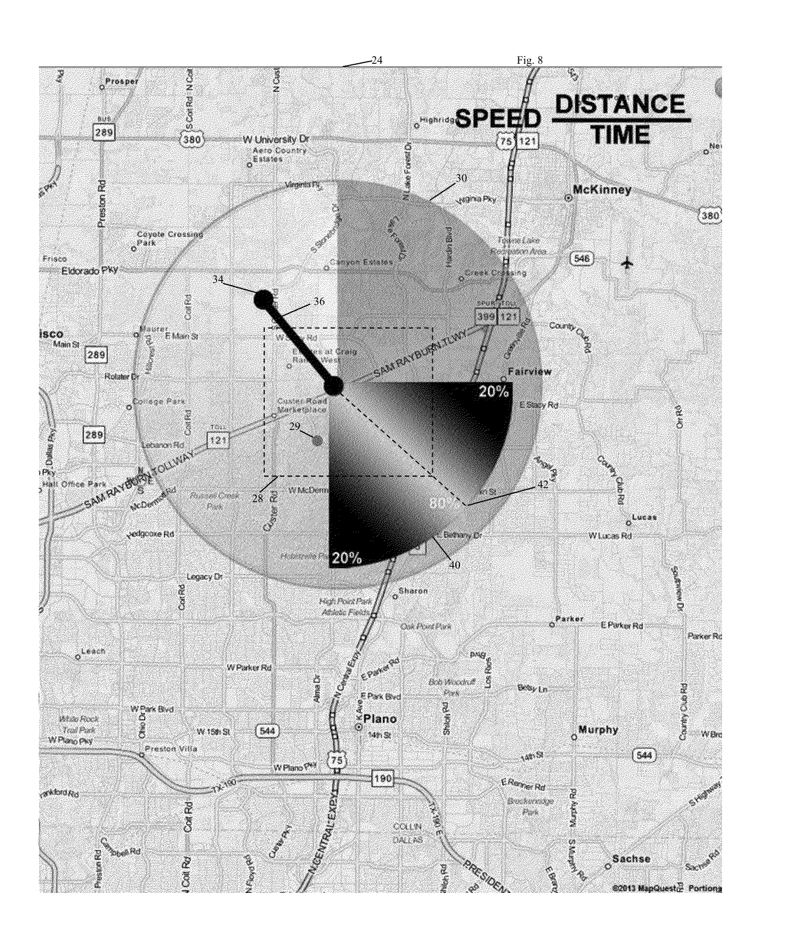

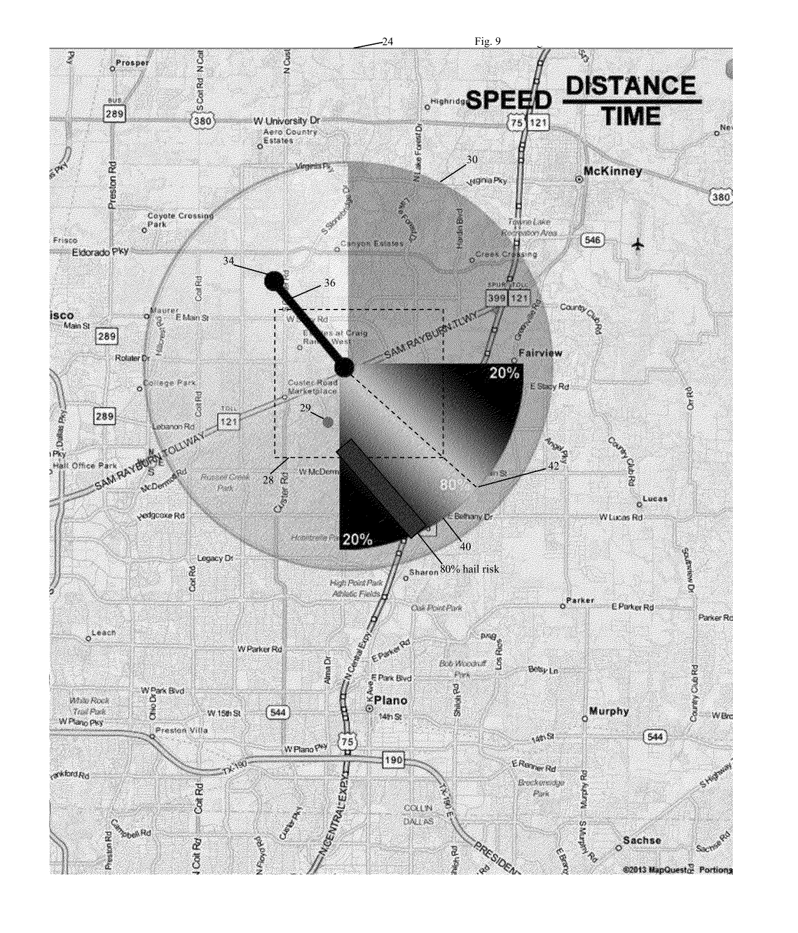

At step 240, the direction of the storm cell is projected. FIGS. 6, 7, 8, 9 depict representative storm cell center 32 34 travel scenarios. FIGS. 6 and 7 depict a current storm cell center 32 and a historical storm cell center 34. FIGS. 8 and 9 depict a current storm cell center 32 and prior historical storm cell centers.

The system 10 employs varying approaches to projecting storm cell direction, individually or in combination. In one configuration, the retrieved meteorological data source weather product includes a direction vector for the storm cell, such as the libnexrad weather product. The system 10 projects from the current storm center 32 using the direction and velocity data of that retrieved vector data.

In an alternate configuration, the system 10 bases the projection on comparison of successive storm cell centers 32 34. For example, the system 10 uses the time and position data of each storm cell center 32 34 to determine the velocity and direction of the storm cell for that time interval. It can define a current storm cell vector 36 based on the data. The system 10 may define historical storm cell vectors 38 based on other historical storm cell centers 34. The system 10 then defines a forecast vector 42, weighting each vector 36 38 accordingly, average, weighted, or otherwise compositing.

In yet another configuration, storm cell travel from prior storm cell events in the same geography or similar conditions is used to define a forecast storm cell vector 42. As mentioned, the approaches may be used individually or in combination, weighting each approach to produce the forecast storm cell vector 42.

At step 250, the system 10 projects the user position based on user travel. For example, the updated user position can be received from the prior disclosed real-time or near real-time systems or from projects route systems such as Google Maps. In certain configurations, the projected user position 29 is based on user velocity, direction of travel, prior travel history, likely or available routes to the destination, and other sources. The system 10 optionally updates the hail risk activity based upon the projections at step 240 and 250.

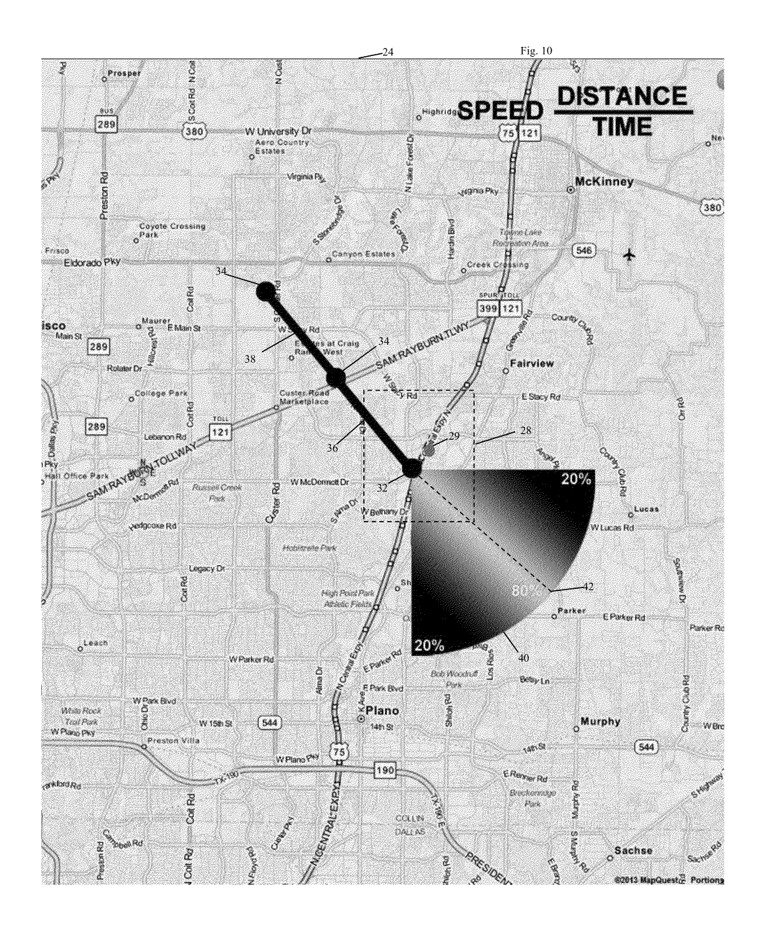

Now referring to FIGS. 8, 9, and 10, at step 260, configurations of the system 10 displays the hail risk activity based on the forecast storm cell vector 42. In certain configurations, the system 10 creates data packets with visual data representing confidence bands. Each confidence band represents a range of certainty of storm hail activity in the forecast storm cell vector 42. The area closest to the forecast storm cell vector 42 is assigned the highest probability. The area further from the forecast storm cell vector 42 are assigned gradually decreasing probability values.

The projected storm cell position probability values may be further modified by projected hail risk probability values to calculate a composite probability value. Specifically, a hail probability value is calculated for the same position as a corresponding projected storm cell position probability value. Accordingly, a projected high probability of storm activity input modified by a low probability of hail activity yields a low composite probability value whereas a projected mid-range probability of storm activity input modified by a high probability of hail activity yields a mid-range composite probability value.

This configuration applies a color gradient from the highest probability value to the lowest probability value. The color gradient overlay is stored as a visual data packet for transmission to the user computer 26 for display 24. Optionally, where the user position 29 is within or proximate a threshold storm cell probability, hail activity risk probability, and/or hail density probability, the system generates a notification for the user. The threshold can be system generated, user input, or a combination thereof. The notification can be in the form of signal on the display 24, an email message, an SMS message, instant message, in-app message, or other forms of communication known in the art.

The system 10 reiterates the steps 200-260 while monitoring, as it is activated.

Insofar as the description above, and the accompanying drawing disclose any additional subject matter that is not within the scope of the single claim below, the inventions are not dedicated to the public and the right to file one or more applications to claim such additional inventions is reserved.

What is claimed is:

1. A method for monitoring and notification of localized hail activity comprising:
receiving contemporaneous user position information, defining a weather monitoring zone encompassing said user position, defining a user travel zone encompassing said user position and within said weather monitoring zone;
receiving meteorological data for said weather monitoring zone from at least one meteorological data source;
determining hail risk within a storm cell for the user travel zone;
projecting a subsequent user position;
projecting a subsequent storm cell position;
comparing the position data of said user travel zone with the position data of said hail risk in said storm cell for overlap, and determining user hail risk as a function of said projected user position and said projected storm cell position.

2. The method of claim 1 further comprising segmenting the overlap regions into probability bands, the probability values increasing as the likelihood of user position coincides with the likelihood of hail activity.

3. The method of claim 1 further comprising transmitting said comparison data for display.

4. The method of claim 1 further comprising conditionally transmitting said comparison data upon a threshold hail risk.

5. The method of claim 1 further wherein said comparison data includes visual depiction of hail risk within the user travel zone.

6. The method of claim 1 further comprising a GPS providing user position information.

7. The method of claim 1 further wherein said meteorological data source is selected from the following: NOAA hail index and nx3hail.

8. The method of claim 1 wherein said projected user position is based on at least one of the following: user velocity, direction of travel, prior travel history, likely route to a destination, and available routes to a destination.

9. The method of claim 1 wherein said projected storm cell position is based on the libnexrad weather product.

10. The method of claim 1 wherein said projected storm cell position is based on at least one of the following: storm sell size, storm cell velocity, wind speed, prior storm cell patterns.

11. A system for monitoring and notification of localized hail activity comprising:
a processor and memory configured embedded with the following instruction set:
to receive contemporaneous user position information, define a weather monitoring zone encompassing said user position, define a user travel zone encompassing said user position and within said weather monitoring zone;
receiving meteorological data for said weather monitoring zone from at least one meteorological data source;
determining hail risk within a storm cell for the user travel zone;
projecting a subsequent user position;
projecting a subsequent storm cell position;
comparing the position data of said user travel zone with the position data of said hail risk in said storm cell for overlap, and determining user hail risk as a function of said projected user position and said projected storm cell position;
comparing said user position with said storm cell position and transmitting data for display, said data comprising hail risk activity within the weather monitor zone by probability bands; and
generating an alert where user position is in or near a threshold probability band.

12. The system of claim 11 wherein said processor is further configured to segment the overlap regions into probability bands, the probability values increasing as the likelihood of user position coincides with the likelihood of hail activity.

13. The system of claim 11 wherein said processor is further configured to transmit said comparison data for display.

14. The system of claim 11 wherein said processor is further configured to conditionally transmitting said comparison data upon a threshold hail risk.

15. The system of claim 11 wherein said comparison data includes visual depiction of hail risk within the user travel zone.

16. The system of claim 11 further comprising a GPS in communication with said processor and providing user position information.

17. The system of claim 11 further wherein said meteorological data source is selected from the following: NOAA hail index and nx3hail.

18. The system of claim 11 wherein said projected user position is based on at least one of the following: user velocity, direction of travel, prior travel history, likely route to a destination, and available routes to a destination.

19. The system of claim 11 wherein said projected storm cell position is based on the libnexrad weather product.

20. The system of claim 11 wherein said projected storm cell position is based on at least one of the following: storm sell size, storm cell velocity, wind speed, prior storm cell patterns.
